(19) United States
(12) Patent Application Publication
(10) Pub. No.: US 2014/0227905 A1
(43) Pub. Date: Aug. 14, 2014

(54) DEVICE AND METHOD FOR IMPEDANCE MATCHING MICROWAVE COAXIAL LINE DISCONTINUITIES

(71) Applicants: Bradley David Knott, Glenwood Spring, CO (US); Raymond Armand Bellefeuille, Scottsdale, AZ (US)

(72) Inventors: Bradley David Knott, Glenwood Spring, CO (US); Raymond Armand Bellefeuille, Scottsdale, AZ (US)

(21) Appl. No.: 13/765,974

(22) Filed: Feb. 13, 2013

(51) Int. Cl. H01R 24/38

(52) U.S. Cl. CPC H01R 24/38
USPC 439/578

(57) ABSTRACT

A coaxial connector has an inner connector. An outer connector is positioned in concentric and radially spaced in relation to the cylindrical inner connector. At least one of the inner connector or outer connector has a first taper region. A dielectric member is positioned between the inner connector and the outer connector.

### BACKGROUND

Embodiments of this disclosure relate generally to coaxial connectors, and more particularly, to a method of impedance matching of microwave coaxial connector.

Microwave coaxial transmission lines and microwave connectors may be characterized by an outer conductor (OC), a dielectric, and a center conductor (CC). The ideal dielectric is generally air. However, physical support of the center conductor in a coaxial environment dictates something other than air for use as the dielectric material. Currently most transmission lines utilize some form of plastic materials with the higher temperature applications utilizing various forms of Teflon including a mixture of Teflon and air. Microwave connectors primarily use Polytetrafluoroethylene (PTFE) for dielectric materials.

Microwave transmission lines are generally terminated with microwave connectors. These terminations typically require transitions in size of the inner and outer conductors. The changes in sizes primarily relate to meeting mechanical requirements such as sealing, captivation, and interface to the mating connector. These transitions are often coincident with the dielectric location and the overall design must include compensation in order to maintain a matched impedance system. Mismatching causes a partial reflection of the signal and an industry common term of Voltage to Standing Wave Ratio (VSWR) may be used to characterize the mismatch. VSWR is a measure of the reflected signal relative to the signal itself.

Microwave connectors face performance degradation with an increase in frequency mainly due to impedance irregularities created by size transitions in the OC and CC. The change in sizes must be compensated for in order to maintain a matched impedance system.

Prior microwave connector design methods calculate the additional capacitance created at the transitions and provides a conjugate inductive section to obtain a desired match. This method has limitations in the amount of frequency band width that the matched transition can be effective. This type of design is characterized by steps in the center conductor, dielectric, and/or outer conductor as well as offset gaps to define the matching section. While the present/prior art design does provide some type of impedance matching, there are still signal reflection issues.

Therefore, it would be desirable to provide a method and connector that overcomes the above problems. The method and resulting matched connector would provide maximum signal throughput by minimizing/eliminating signal reflection.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

A coaxial connector has an inner conductor. An outer conductor is positioned in concentric and radially spaced in relation to the inner conductor. A dielectric member is positioned between the inner conductor and the outer conductor, wherein the dielectric member has a curved surface.

A coaxial connector has a cylindrical inner conductor. A cylindrical outer conductor is positioned in concentric and radially spaced in relation to the inner conductor. A tapered surface is formed on at least one of the inner conductor or outer conductor. A dielectric member is formed at least partly between the inner conductor and the outer conductor. A curved surface is formed on the dielectric member, wherein the curve surface follows the tapered surface.

A coaxial connector has a cylindrical inner conductor. A cylindrical outer conductor is positioned in concentric and radially spaced in relation to the cylindrical inner conductor. A tapered surface is formed on at least one of the inner cylindrical conductor or outer cylindrical conductor. A dielectric member is formed at least partly between the cylindrical inner conductor and the cylindrical outer conductor. A curved surface is formed on the dielectric member, wherein the curve surface is an approximately catenary curve which follows the tapered surface, wherein the curved surface allows electromagnetic wave to propagate through while maintaining transverse propagation.

The features, functions, and advantages may be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1A is an end view of a portion of a prior art microwave connector design;

FIG. 1B is a cross section of the portion of the microwave connector of FIG. 1A taken along lines A-A showing a diameter transition for the prior art microwave connector design;

FIG. 2A is an end view of one embodiment of the present invention;

FIG. 2B shows a cross section of FIG. 2A taken along lines A-A showing the design method of the present invention for a microwave coaxial connector dielectric impedance match section;

FIG. 3A is an end view of one another embodiment of the present invention;

FIG. 3B shows a cross section of FIG. 3A taken along lines A-A showing a stepped outer conductor and a straight center conductor;

FIG. 4A is an end view of one another embodiment of the present invention;

FIG. 4B shows a cross section of FIG. 4A taken along lines A-A wherein the inner and outer conductors are transitioned using tapers and the dielectric employs a “catenary” curve;

FIG. 5A is an elevated perspective view of one embodiment of the microwave coaxial connector of the present invention;

FIG. 5B is a cross-section view of the microwave coaxial connector of FIG. 5A; and

FIG. 6A-6D show charts for determining a shape of the catenary curve.

### DESCRIPTION OF THE APPLICATION

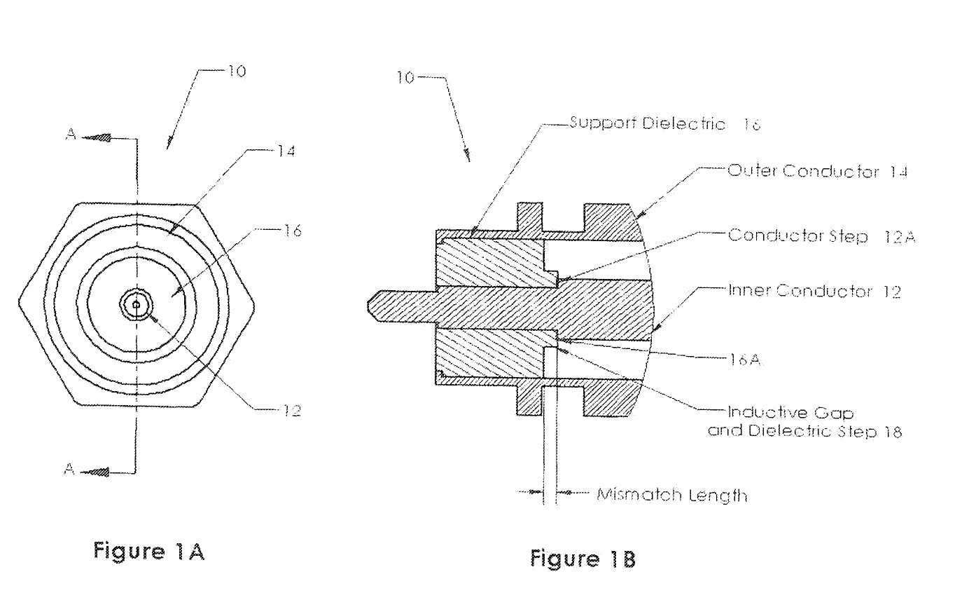

Referring to FIG. 1A-1B, a portion of a prior art microwave connector 10 is shown. The microwave connector 10 generally has an inner conductor 12 and an outer conductor 14. The inner conductor 12 may be supported by a dielectric 16. While the ideal dielectric may be air, physical support of the inner conductor 12 in the microwave connector 10 generally dictates something other than air for use as the dielectric 16. In general, some form of plastic materials may be used with the higher temperature applications utilizing various forms of Teflon including a mixture of Teflon and air. In accordance with one embodiment, Polytetrafluoroethylene (PTFE) may be used for the dielectric 16.

In the prior art, when designing the connector 10, one would calculate the additional capacitance created at the diameter transitions in the transmission line and provided a matching conjugate inductive section of transmission line. This type of design is characterized by diameter steps 12A and 16A on the inner conductors 12 and dielectric 16 respectively, as well as offset gaps 18 defining the matching inductive sections. While the present/prior art design does provide some type of impedance matching, there are still signal reflection issues.

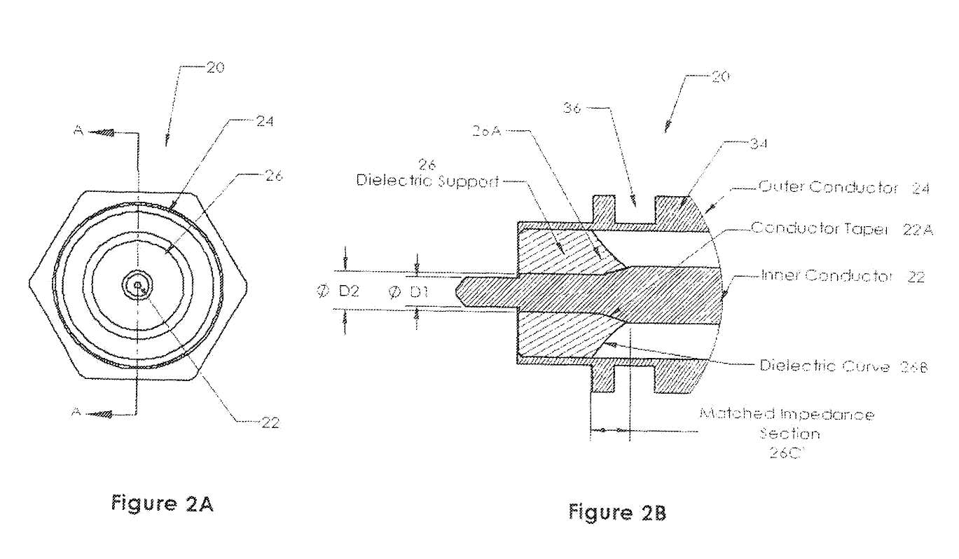

Referring now to FIGS. 2A-2B, a section of a microwave connector 20 of the present invention is shown. The microwave connector 20 generally has an inner conductor 22 and an outer conductor 24. The inner conductor 22 may be supported by a dielectric 26. In general, some form of plastic materials may be used with the higher temperature applications utilizing various forms of Teflon including a mixture of Teflon and air. In accordance with one embodiment, Polytetrafluoroethylene (PTFE) may be used for the dielectric 26.

In the present embodiment, the inner conductor 22 may have a solid cylindrical shape. The outer conductor 24 may be comprised of a hollow cylindrical shape. The outer conductor 24 may be positioned in a concentric and radialy spaced in relation to the inner conductor 22. Both of the inner and outer conductors 22 and 24 respectively, may be separated by the dielectric 26 provided partly between them.

The microwave connector 20 replaces the diameter step transition of the prior art with a curve “catenary” transition. As seen more clearly in FIG. 2B, inner conductor 22 may have one or more tapered transition regions 22A. Each tapered region 22A is a transition wherein the inner conductor 22 changes widths. As shown in FIG. 2B, in the tapered transition region 22A, the inner conductor 22 changes from having a first end diameter D1 to a second diameter D2. However, tapered transition regions 22A is now curved instead of stepped.

The dielectric 26 may have a tapered section 26A which corresponds to the tapered transition regions 22A of the inner conductor 22. The dielectric 26 may further have one or more curved regions 26B. This dielectric curved region 26B corresponds to the tapered transition region 22A on the inner conductor 22 thru the use of Snell's law of refraction. The transition into and out of the dielectric 26 is a matched impedance section 26C of transmission line, unlike prior art's un-matched inductive section.

The dielectric curved region 26B determines the progressive change of speed of the electromagnetic wave resulting in a linear output. The dielectric curved region 26B design takes (avoids) non-linear electromagnetic wave propagation (caused by changing propagation velocity) and returns it to a linear propagation. The shape of the dielectric curved region 26B may be broadly defined as any non-perpendicular incident boundary layer surface that the electromagnetic wave propagates through while maintaining transverse propagation. A description of calculating the dielectric curved region 26B will be described below.

The key to the design microwave connector 20 is the dielectric curved region 26B (Catenary) in combination with the tapered transition region 22A on the inner conductor 22. The shape of the dielectric curved region 26A may vary from design to design depending on the dielectric material, the length of the tapered transition region 22A, etc. The dielectric curved region 26A can approximate and equal an angled straight line effectively resulting in a taper.

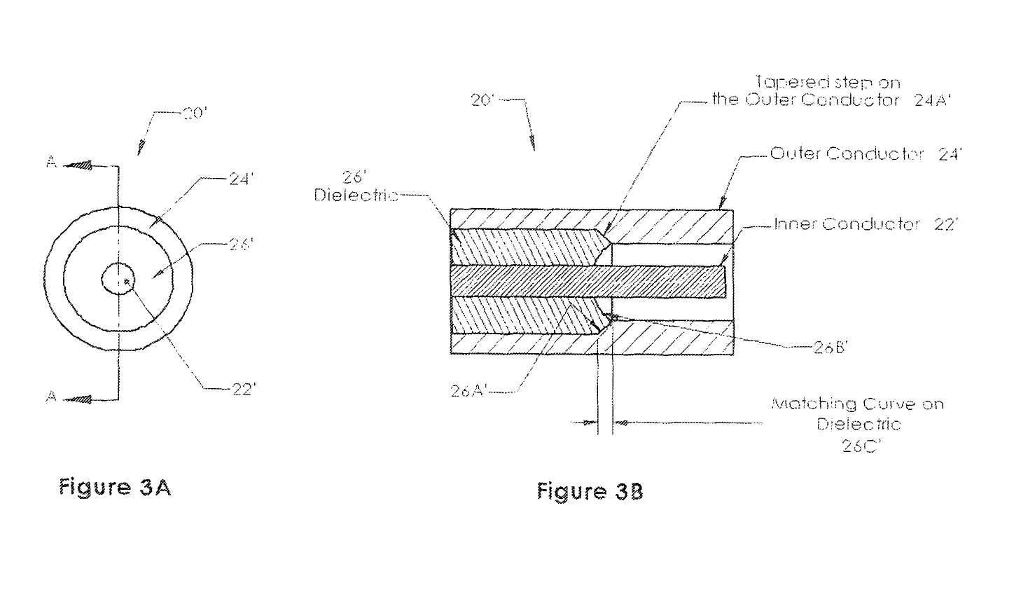

Referring now to FIGS. 3A-3B, another embodiment of a microwave connector 20′ of the present invention is shown. The microwave connector 20′ is similar to that shown in FIGS. 2A-2B. The microwave connector 20′ generally has an inner conductor 22′ and an outer connector 24′. The inner conductor 22′ may be supported by a dielectric 26′. In general, some form of plastic materials may be used with the higher temperature applications utilizing various forms of Teflon including a mixture of Teflon and air. In accordance with one embodiment, Polytetrafluoroethylene (PTFE) may be used for the dielectric 26′.

In the present embodiment, the inner conductor 22′ may have a solid cylindrical shape. The outer conductor 24′ may be comprised of a hollow cylindrical shape. The outer conductor 24′ may be positioned in a concentric and radialy spaced in relation to the inner conductor 22′. Both of the inner and outer conductors 22′ and 24′ respectively, may be separated by the dielectric 26′ provided partly between them.

In the present embodiment, the inner conductor 22′ is approximately straight. The outer conductor 24′ has a tapered transition region 24A′. The dielectric 26′ may have a tapered transition region 26A′ which corresponds to the tapered transition region 24A′ of the outer conductor 24′. The dielectric 26′ may further have one or more curved regions 26B′. This dielectric curved region 26B′ corresponds to the tapered transition region 24A on the outer conductor 24′ thru the use of Snell's law of refraction. The transition into and out of the dielectric 26′ is a matched impedance section 26C′ of transmission line, unlike prior art's un-matched inductive section.

The dielectric curved region 26B′ determines the progressive change of speed of the electromagnetic wave resulting in a linear output. The dielectric curved region 26B′ design takes (avoids) non-linear electromagnetic wave propagation (caused by changing propagation velocity) and returns it to a linear propagation. The shape of the dielectric curved region 26B′ may be broadly defined as any non-perpendicular incident boundary layer surface that the electromagnetic wave propagates through while maintaining transverse propagation. A description of calculating the dielectric curved region 26B′ will be described below.

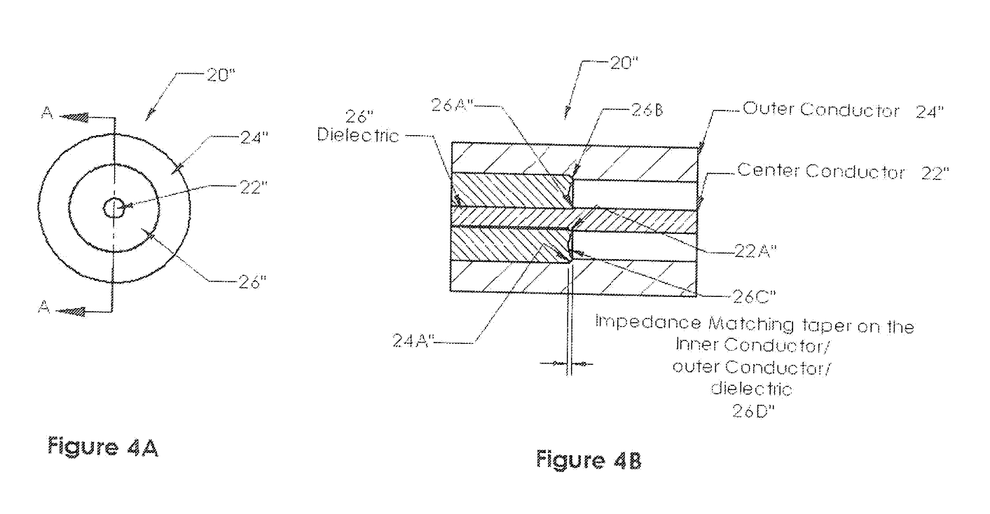

Referring now to FIGS. 4A-4B, another embodiment of a microwave connector 20″ of the present invention is shown. The microwave connector 20″ is similar to that shown in FIGS. 2A-3B. The microwave connector 20″ generally has an inner conductor 22″ and an outer conductor 24″. The inner conductor 22″ may be supported by a dielectric 26″. In general, some form of plastic materials may be used with the higher temperature applications utilizing various forms of Teflon including a mixture of Teflon and air. In accordance with one embodiment, Polytetrafluoroethylene (PTFE) may be used for the dielectric 26″.

In the present embodiment, the inner conductor 22″ may have a solid cylindrical shape. The outer conductor 24″ may be comprised of a hollow cylindrical shape. The outer conductor 24″ may be positioned in a concentric and radialy spaced in relation to the inner conductor 22″. Both of the inner and outer conductors 22″ and 24″ respectively, may be separated by the dielectric 26″ provided partly between them.

The inner conductor 22″ may have one or more tapered transition regions 22A″. The outer conductor 24″ may also have one or more tapered transition regions 24A″. The dielectric 26″ may have a first tapered transition region 26A″ which corresponds to the tapered transition regions 22A″ of the inner conductor 22″. The dielectric 26″ may further have a second tapered transition region 26B″ which corresponds to the tapered transition regions 24A″ of the outer conductor 24″. The dielectric 26″ may further have one or more curved regions 26C″. The dielectric curved region 26C″ corresponds to an area positioned between the tapered transition region 24A″ on the outer conductor 24″ and the transition regions 22A″ of the inner conductor 22″. The curvature of the dielectric curved region 26C″ is based on the use of Snell's law of refraction. The transition into and out of the dielectric 26″ is a matched impedance section 26D″ of transmission line, unlike prior art's un-matched inductive section.

The dielectric curved region 26C″ determines the progressive change of speed of the electromagnetic wave resulting in a linear output. The dielectric curved region 26C″ design takes (avoids) non-linear electromagnetic wave propagation (caused by changing propagation velocity) and returns it to a linear propagation. The shape of the dielectric curved region 26C″ may be broadly defined as any non-perpendicular incident boundary layer surface that the electromagnetic wave propagates through while maintaining transverse propagation. A description of calculating the dielectric curved region 26C″ will be described below.

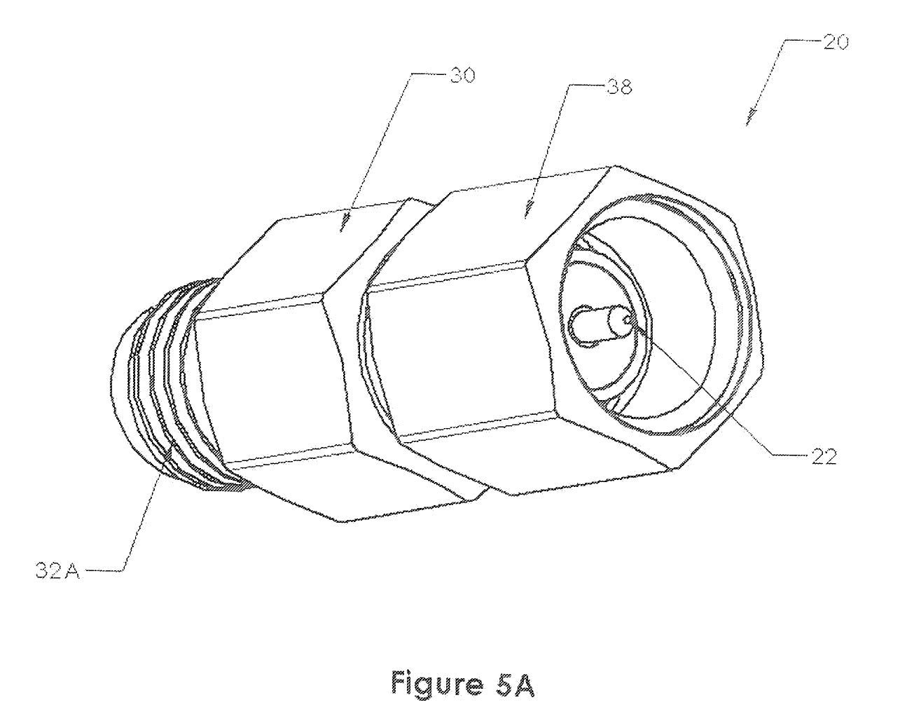

Referring now to FIGS. 5A-5B, the microwave connector 20 shown in FIGS. 2A-2B is shown in greater detail. The microwave connector 20 has the inner conductor 22 which may have one or more tapered transition regions 22A. The dielectric 26 may have a tapered section 26A which corresponds to the tapered transition regions 22A of the inner conductor 22. The dielectric 26 may further have one or more curved regions 26B. This dielectric curved region 26B corresponds to the tapered transition region 22A on the inner conductor 22 thru the use of Snell's law of refraction. The transition into and out of the dielectric 26 is a matched impedance section 26C of transmission line, unlike prior art's un-matched inductive section.

The microwave connector 20 may have a first socket 30. One end of the first socket may have a connection device 32 formed thereon. The connection device 32 may allow a transmission line to be attached to one end of the microwave connector 20. In accordance with one embodiment of the present invention, the connection device 32 is threading 32A. The above is given as an example and should not be seen in a limiting manner.

A second end of the first socket 30 is generally open. This may allow the first socket 30 to be positioned over at least a portion of an outer surface 34 of the outer conductor 24. Remaining portions of the outer surface 34 of the outer conductor 24 may be exposed. As shown in FIGS. 2B and 5B, the exposed portions of the outer conductor 24 may have one or more notches 36 formed on an outer surface 34 therein. The notches 36 may be used to secure the first socket 30 to a second socket 38. The notches 36 may be used as a locking device to secure the outer conductor 24 with the second socket 38.

### Catenary Curve Calculations

Electromagnetic energy, either Microwave or optic are one in the same. The major difference is that the wavelength (frequency) is approximately one million times longer for the microwave frequencies. This difference must be kept in the forefront in all analysis of microwave waves using optical methodologies. Another way of saying the same thing is: there are very few structures in optics that are in the in the same physical size as a wavelength. In microwave many structures are larger than a wavelength. In particular, the physical size of coax TEM cable by definition as less than a wavelength in outside diameter.

Using ray diagrams and geometric method on microwave parts is not completely correct but it does lead to some simplifications of models and can prove very useful. In particular, the matching of microwave connectors is greatly simplified and some meaningful physical possibilities result from using optical methods.

Two physical mechanisms occur when conductors change size in a coaxial transmission line. The energy is either diffracted or it is refracted or both. If there is no change in the material that the energy is propagating in than diffraction occurs at the change. If there is a material change, then the primary physical effect is due to refraction. Diffraction may also happen but its effect is secondary to the material change and refraction.

As soon as one begin looking at refraction, Snell's Law and Fresnel's transmission, reflection, refraction analysis become the analysis tools. With these tools, the complete set of calculations can be performed to show exactly where EM energy is and all its paths. The limiting factor, it is done in optical wavelengths and a material interface is always assumed to be much, much greater than a wavelength.

At first analysis, Fresnel equations prove there are always reflected waves off an interface between two materials with and abrupt changes in refractive index values. Many of the articles go out of their way to spell out that the only way reflection does not occur is when the refractive index of the first material is equal to the index of the second. There are several optical techniques to reduce reflection by applying a step index coating that has an index that is between the indexes of the two primary materials. These coating are controlled to either ¼ or ½ wavelength in thickness to make them effective. This first impression is accurate for surfaces that are much larger than a wavelength and can be modifies when considering surfaces that are wavelength or less.

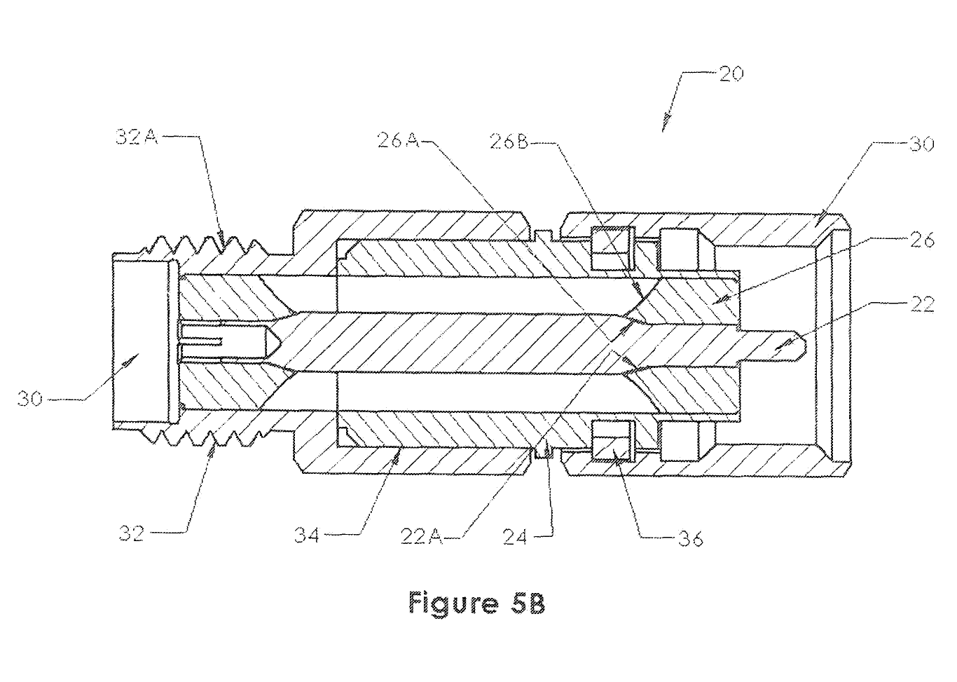

Referring to FIGS. 6A-6D, for the dielectric supports within a coax connector, the dimensions are such that, the dielectric index can be varied linearly from one propagating material to the other. Notice that if we approximate a continuously changing index of refraction by a sequence of thin uniform plates, as we add more plates the ratio of n2/n1 from one region to the next approaches 1, and so according to Snell's Law the value of Angle 2 approaches the value of Angle 1. From Fresnel's equations we see that in this case the fraction of incident energy that is reflected goes to zero. With the varying dielectric constant, there is a set of shapes that provide, if not absolute zero reflection, all practicable purposes a reflection less surface transition and therefore a near perfect impedance match.

### Snell

N1*sin(angle1)=n2*sin(angle2) or n2/n1=sin(angle 1)/sin(angle2)

The surface shape that provides a perfect match is the Catenary. Y=m*cos h(x/m). M is a constant

The catenary is not an easily machined shape and in most if not all cases a defined radius is more than adequate for microwave work; the catenary is still useful for determining the specification for the radius. From optics and Maxwell, the image is continuous across the dielectric boundary. This simple concept spells out the conditions for determining M for impedance matching catenary shape. The minimum transition surface is when the distance of the centenary equals larger distance of the (N2) dielectric filled space between the conductors. A longer distance can be used but with a lower angle for the dielectric material to be captivated.

$$Fresnel$$

$$R = \frac{{I}_{reflected}}{{I}_{incident}} = \frac{1}{2} [ \frac{{sin}^{2} ( {θ}_{1} - {θ}_{2} )}{{sin}^{2} ( {θ}_{1} + {θ}_{2} )} + \frac{{tan}^{2} ( {θ}_{1} - {θ}_{2} )}{{tan}^{2} ( {θ}_{1} + {θ}_{2} )} ]$$

### Catenary for Reflectionless Surface:

Y=m*cos h(x/m); x is the smaller of the distances between conductors and is always at the minimum of the catenary
S=surface length of the catenary=m*sin(x/m)=first derivative of M*cos h(x/m)=distance of the larger of the distances between conductors

### Common Results:

Air/PTFE interface; 1/1.43 refraction index-1/2.15 dielectric constant
Classic dia. 0.161/0.070 PTFE, 0.0488 PTFE, step is on the center conductor and no step on the outer conductor

Space between conductors is 0.0561 for PTFE Transmission line and 0.0455 for the Air Transmission line Catenary y=m*cos h(x/m) Y′=0.0561=m*sin h(x/m)—angle of the dielectric to the center conductor at the center conductor is 55 degrees (Brewster's angle). The reflection angle is 35 degrees (Snell's law) and the center conductor is tapered to 20 Degrees with respect to the transmission line sections on center conductors. M is equal to 0.03975 and the end points of the catenary are (0, 0) and (0.0455, 0.0290).

While the invention has been particularly shown and described with reference to preferred embodiments thereof, it will be understood by those skilled in the art that the foregoing and other changes in form and details may be made therein without departing from the spirit and scope of the invention.

What is claimed is:

1. A coaxial connector comprising:
an inner conductor;
an outer conductor positioned in concentric and radially spaced in relation to the inner conductor; and
a dielectric member positioned between the inner conductor and the outer conductor, wherein the dielectric member has a curved surface.

2. The coaxial connector in accordance with claim 1, wherein the curved surface is a non-perpendicular surface which allows electromagnetic wave to propagate through while maintaining transverse propagation.

3. The coaxial connector in accordance with claim 1, further comprising a first tapered region is formed on the inner conductor.

4. The coaxial connector in accordance with claim 3, wherein the curved surface is formed to follow along the first tapered region.

5. The coaxial connector in accordance with claim 1, further comprising a first tapered region formed on the outer conductor.

6. The coaxial connector in accordance with claim 5, wherein the curved surface follows the first tapered region.

7. The coaxial connector in accordance with claim 1, further comprising:
a first tapered region formed on the inner conductor; and
a second tapered formed on the outer conductor.

8. The coaxial connector in accordance with claim 7, wherein the curved surface is formed to follow the first tapered region to the second tapered region.

9. The coaxial connector in accordance with claim 3, wherein the inner conductor comprises a first end diameter and a second end diameter, wherein the first end diameter is larger than the second end diameter, the first end diameter tapers to the second end diameter along the first tapered region.

10. The coaxial connector in accordance with claim 1, further comprising a socket positioned over the outer conductor.

11. The coaxial connector in accordance claim 1, wherein the curved surface is a catenary curve.

12. A coaxial connector comprising:
a cylindrical inner conductor;
a cylindrical outer conductor positioned in concentric and radially spaced in relation to the cylindrical inner conductor;
a tapered surface formed on at least one of the inner conductor or outer conductor;
a dielectric member formed at least partly between the inner conductor and the outer conductor; and
a curved surface formed on the dielectric member, wherein the curve surface follows the tapered surface.

13. The coaxial connector in accordance with claim 12, wherein the curved surface is a non-perpendicular surface which allows electromagnetic wave to propagate through while maintaining transverse propagation.

14. The coaxial connector in accordance with claim 12, wherein the tapered surface is formed on the inner conductor.

15. The coaxial connector in accordance with claim 12, wherein the tapered surface is formed on the outer conductor.

16. The coaxial connector in accordance with claim 12, wherein the tapered surface comprises:
a first taper region formed on the inner conductor; and
a second taper formed on the outer conductor.

17. The coaxial connector in accordance with claim 16, wherein the curved surface is formed to follow the first taper region to the second taper region.

18. The coaxial connector in accordance claim 12, wherein the curved surface is a catenary curve.

19. A coaxial connector comprising:
a cylindrical inner conductor;
a cylindrical outer conductor positioned in concentric and radially spaced in relation to the cylindrical inner conductor;
a tapered surface formed on at least one of the inner cylindrical conductor or outer cylindrical conductor;
a dielectric member formed at least partly between the cylindrical inner conductor and the cylindrical outer conductor; and
a curved surface formed on the dielectric member, wherein the curve surface is an approximately catenary curve which follows the tapered surface, wherein the curved surface allows electromagnetic wave to propagate through while maintaining transverse propagation.

20. The coaxial connector in accordance with claim 19, further comprising a socket positioned over the outer connector.
